(19) United States
(12) Patent Application Publication
(10) Pub. No.: US 2023/0334828 A1
(43) Pub. Date: Oct. 19, 2023

(54) DATA DENSIFICATION METHOD, DATA DENSIFIER USING THE SAME, AND SENSE CHIP

(71) Applicant: Brillnics Singapore Pte. Ltd., Singapore (SG)

(72) Inventors: Chi-Chun WANG, Zhubei City (TW); Meng-Ying TSAI, Zhubei City (TW)

(21) Appl. No.: 18/300,720

(22) Filed: Apr. 14, 2023

(30) Foreign Application Priority Data
Apr. 15, 2022 (CN) 202210398293.8

(51) Int. Cl. G06V 10/764; G06V 10/80

(52) U.S. Cl. CPC G06V 10/764; G06V 10/809

(57) ABSTRACT

The present invention proposes a data densifier comprising a plurality of first operation units and a second operation unit. The plurality of first operation units are respectively configured to be instantiated according to classification information, and the plurality of instantiated first operation units are configured to densify a plurality of sub data included in input data into a plurality of sub densified data. The second operation unit is configured to be instantiated according to the classification information, and the instantiated second operation unit is configured to merge the plurality of sub densified data from the plurality of first operation units into densified data. In addition, a data densification method used by the data densifier and a sense chip comprising the data densifier are also proposed.

### CROSS-REFERENCE TO RELATED APPLICATIONS

This application is based on and claims the benefit of priority from Chinese Patent Application Serial No. 202210398293.8 (filed on Apr. 15, 2022), the contents of which are hereby incorporated by reference in their entirety.

### TECHNICAL FIELD

The present invention relates to a data densification method. Furthermore, the present invention relates to a data densification method, a data densifier and a sense chip which can realize low latency and high throughput.

### BACKGROUND

Data densification is a common means in the field of data transmission, which filters specific data units from the overall data for transmission according to the requirements of a system to reduce power consumption. For example, in the field of image sensing, the system may have update requirements for pixels in some specific regions, while may have no update requirements for pixels in other specific regions. From another perspective, the system may be interested in image changes in some specific regions (for example, a region of interest (RGI)), or may not be interested in image changes in other specific regions. Therefore, compared with transmitting an entire sense image, if the sense chip can filter out and transmit specific pixel data to the system according to an instruction of the system after obtaining the sense image, the transmission amount may be reduced, and then the power consumption generated during transmission may be reduced. Hereinafter, description will be made by taking FIG. 1 as an example.

In FIG. 1, one row of pixel data PD of the sense image comprises 8 data units p0 to p7. Information of interest BM (for example, a dot plot from the system) may indicate whether each data unit is a data unit of interest. In the example of FIG. 1, the data units p1, p2, p4, p6 and p7 are data units of interest, whereas the data units p0, p3 and p5 are not data units of interest. Therefore, after data densification, the data units p1, p2, p4, p6, and p7 that are data units of interest may be filtered out as to-be-output data units OUT for subsequent output.

In practical operation, it is an intuitive and achievable approach to sequentially compare each data unit with the information of interest BM. However, such approach requires one time cycle for each data unit to compare with the information of interest BM, which may lead to a very serious output latency when the data scale is large.

On the other hand, it is another intuitive approach to simultaneously compare all data units in the overall data with the information of interest BM in one time cycle, which can avoid the output latency. However, when the data scale is large, the exponential growth in the number of operation elements makes this approach impractical.

### SUMMARY

In view of this, the present invention provides a data densification method which is capable of providing low-latency densified data output in achievable hardware.

A data densifier in an embodiment of the present invention comprises a plurality of first operation units and a second operation unit. The plurality of first operation units are respectively configured to be instantiated according to classification information, and the plurality of instantiated first operation units are configured to densify a plurality of sub data included in input data into a plurality of sub densified data. The second operation unit is configured to be instantiated according to the classification information, and the instantiated second operation unit is configured to merge the plurality of sub densified data from the plurality of first operation units into densified data.

A sense chip in an embodiment of the present invention comprises a data densifier, a light sensing element and a transmission element. The data densifier comprises a plurality of first operation units and a second operation unit. The plurality of first operation units are respectively configured to be instantiated according to classification information, and the plurality of instantiated first operation units are configured to densify a plurality of sub data included in input data into a plurality of sub densified data. The second operation unit is configured to be instantiated according to the classification information, and the instantiated second operation unit is configured to merge the plurality of sub densified data from the plurality of first operation units into densified data. The light sensing element is coupled to the data densifier and configured to generate input data. The transmission element is coupled to the data densifier and configured to be coupled to an external element to output valid data of the densified data to the external element.

The data densification method in the embodiment of the present invention comprises: receiving classification information; instantiating a plurality of first operation units according to the classification information; instantiating a second operation unit according to the classification information; densifying a plurality of sub data included in input data into a plurality of sub densified data respectively by means of the plurality of instantiated first operation units; and merging the plurality of sub densified data from the first operation units into densified data by means of the instantiated second operation unit.

To sum up, according to the data densification method, the data densifier using the data densification method, and the sense chip which are proposed in the embodiments of the present invention, a plurality of sub data included in input data are densified into a plurality of sub densified data first, and then the plurality of sub densified data are merged into densified data. The sense chip in the embodiment of the present invention may output valid data of the densified data rather than all the input data. Accordingly, low latency may be achieved while reducing output power consumption.

### DESCRIPTION OF THE DRAWINGS

One or more implementations of the present invention will be described below with reference to the figures and examples.

FIG. 1 shows a schematic diagram of data densification.

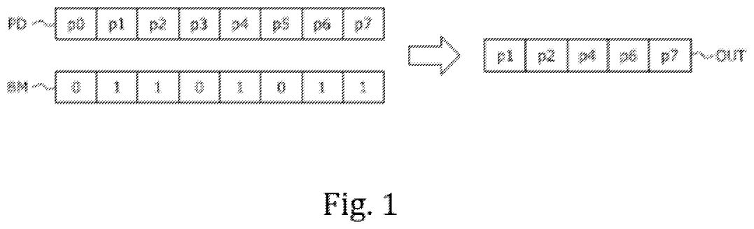

FIG. 2 shows a schematic block diagram of a sense chip in an embodiment of the present invention.

FIG. 3 shows a schematic block diagram of a data densifier in an embodiment of the present invention.

FIG. 4 shows a schematic diagram of a data densifier in an embodiment of the present invention.

FIG. 5A shows a schematic diagram of a first operation unit in an embodiment of the present invention.

FIG. 5B shows a schematic diagram of an instantiated first operation unit in an embodiment of the present invention.

FIG. 5C shows a schematic diagram of a first operation unit in an embodiment of the present invention.

FIG. 6A shows a schematic diagram of a second operation unit in an embodiment of the present invention.

FIG. 6B shows a schematic diagram of a second operation unit in an embodiment of the present invention.

FIG. 7 shows a flowchart of a data densification method in an embodiment of the present invention.

### DETAILED DESCRIPTION

The following description contains specific information about the exemplary implementations of the present invention. The figures and accompanying detailed descriptions in the present invention are only for exemplary implementations. However, the present invention is not limited to these exemplary implementations. Those skilled in the art will be aware of other variations and implementations of the present invention. In addition, the figures and illustrations in the present invention are generally not drawn to scale and do not correspond to actual relative dimensions.

The term “coupling” is defined as connection, either direct connection or indirect connection through intermediate elements, and is not necessarily limited to physical connection. The term “comprise” or “include” as used herein means “including, but not limited to,” which clearly indicates the open relationship of the combinations, groups, series, and equivalents described.

The embodiments herein will adopt a sense chip to illustrate the data densifier and the data densification method. However, the present invention is not limited thereto. In other embodiments, the data densifier and data densification method of the present invention can also be used for data transmission in other fields.

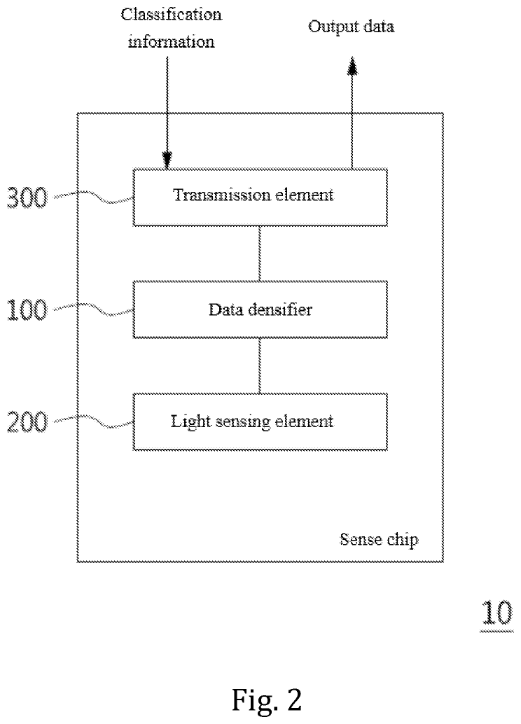

FIG. 2 shows a schematic block diagram of a sense chip in an embodiment of the present invention.

Referring to FIG. 2, in this embodiment, a sense chip 10 is a chip which is configured to receive external control, and may perform light sensing according to the external control and acquire and send back image data. The sense chip 10 comprises a data densifier 100, a light sensing element 200 and a transmission element 300. The light sensing element 200 is coupled to the data densifier 100, and the data densifier 100 is coupled to the transmission element 300.

In this embodiment, the light sensing element 200 is configured to convert optical signals into electrical signals to generate image data. For example, the light sensing element 200 may be a Charge Coupled Device (CCD), a Complementary Metal-Oxide Semiconductor (CMOS) element or another type of light sensing element, and the image data may be array data of 3 million, 12 million, 108 million or other pixels, which will not limited in the present invention.

In this embodiment, the transmission element 300 is configured to be coupled to an external element to serve as a medium for the data densifier 100 to communicate with the external element. For example, the transmission element 300 may be used as at least one pin of the sense chip 10 to output data from the data densifier 100 to the external element such as an external processor, etc. during operation. In some embodiments, the transmission element 300 is further configured to receive classification information (described in detail later) from the external element to provide the classification information to the data densifier 100. In some embodiments, the above classification information may be generated by other elements included in the sense chip 10 instead of being obtained from the external element through the transmission element 300. In other words, the present invention does not limit the way for the data densifier 100 to obtain the classification information.

In this embodiment, the light sensing element 200 inputs the generated image data as input data to the data densifier 100. After obtaining the input data and the classification information, the data densifier 100 converts the input data into densified data according to the classification information, and the transmission element 300 outputs the valid data of the densified data as output data to the external element. Particularly, the number of data units of the output data output by the transmission element 300 is not greater than the number of data units of the input data, so the sense chip 10 in this embodiment can save power consumption generated during transmission as compared with outputting the overall input data to the external element.

It must be noted that each data unit of the input data may comprise one or more bits. The present invention is not limited thereto. For example, one pixel data of the image data as input data may be regarded as one data unit, and each pixel data or data unit may comprise 8 bits (for example, gray scale) or 24 bits (for example, 8 bits each for red, green and blue), etc. The present invention is not limited thereto.

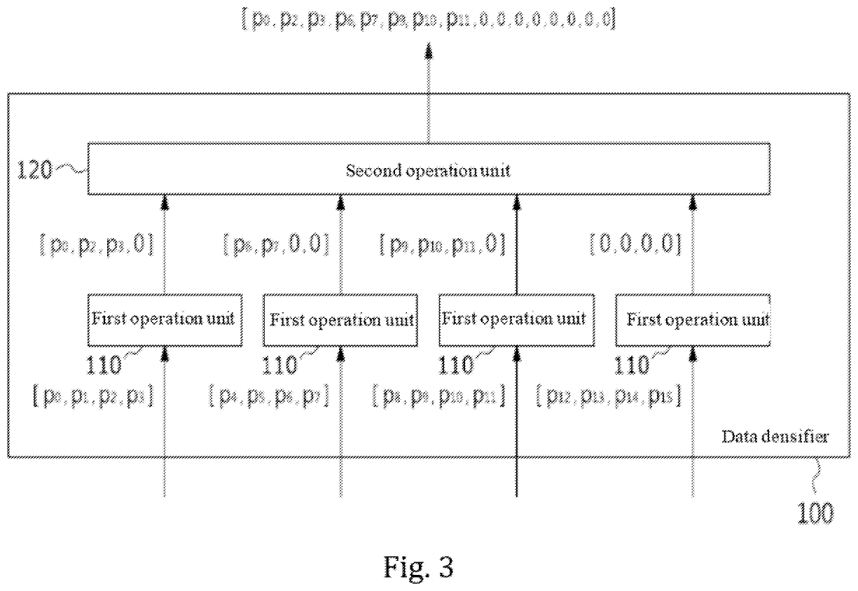

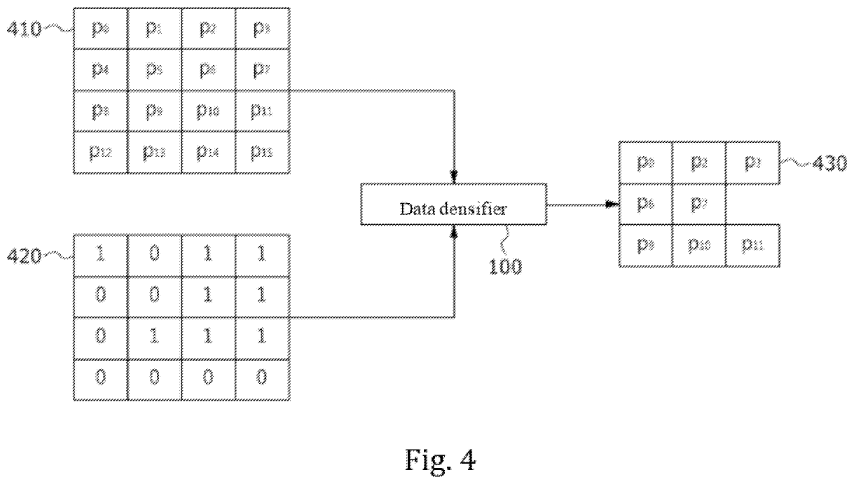

FIG. 3 shows a schematic block diagram of a data densifier in an embodiment of the present invention; and FIG. 4 shows a schematic diagram of a data densifier in an embodiment of the present invention.

Referring to FIG. 3 first, in this embodiment, a data densifier 100 comprises a plurality of first operation units 110 and a second operation unit 120. In this embodiment, the plurality of first operation units 110 are constructed by, for example, a plurality of identical logic circuits, and the second operation unit 120 is also constructed by logic circuits. However, the present invention is not limited thereto. In some embodiments, the first operation units 110 may also be constructed by different logic circuits or partially identical and partially different logic circuits. In some embodiments, the first operation units 110 and the second operation unit 120 may also be implemented by software.

The data densifier 100 receives input data and classification information, where the input data may be divided into a first type of data and a second type of data according to the classification information. Specifically, the input data may comprise a plurality of data units, and the classification information may be configured to indicate whether each data unit belongs to the first type of data or the second type of data. For example, the input data may be, for example, image data from the light sensing element 200, and the classification information may be, for example, information of interest from the external processor, configured to indicate which pixel data of the image data belong to data of interest (for example, the first type of data) or which pixel data of the image data do not belong to data of interest (for example, the second type of data).

Referring to FIG. 4, in this embodiment, the input data 410 of the data densifier 100 is, for example, 4*4 two-dimensional array data, including 16 data units p0 to p15. On the other hand, the classification information 420 is, for example, 4*4 two-dimensional array data. According to the classification information 420, the data units p₀, p₂, p₃, p₆, p₇, p₉, p₁₀ and p₁₁ are the first type of data, and the data units p₁, p₄, p₅, p₈, p₁₂, p₁₃, p₁₄ and p₁₅ are the second type of data.

The input data 410 comprises, for example, a plurality of sub data, and the plurality of first operation units 110 are, for example, in one-to-one correspondence with the plurality of sub data. In this embodiment, one sub data is, for example, one row of input data 410. Therefore, the input data 410 comprises first sub data (for example, [p₀, p₁, p₂, p₃]), second sub data (for example, [p₄, p₅, p₆, p₇]), third sub data (for example, [p₈, p₉, p₁₀, p₁₁]) and fourth sub data (for example, [p₁₂, p₁₃, p₁₄, p₁₅]). However, the present invention is not limited thereto. In other embodiments, those skilled in the art may divide the input data according to their needs to obtain a plurality of sub data.

Each data unit in the input data 410 corresponds to at least one bit of the classification information 420 to indicate whether the data unit belongs to the first data type or the second data type. In this embodiment, the data units are in one-to-one correspondence with the bits in the classification information 420. Specifically speaking, one row of the classification information 420 comprises four bits, corresponding to one sub data. Therefore, the classification information 420 comprises a first row of sub information (for example, [1, 0, 1, 1]) corresponding to the first sub data, a second row of sub information (for example, [0, 0, 1, 1]) corresponding to the second sub data, a third row of sub information (for example, [0, 1, 1, 1]) corresponding to the third sub data, and a fourth row of sub information (for example, [0, 0, 0, 0]) corresponding to the fourth sub data.

For ease of illustration, in a number of embodiments herein, a 4*4 two-dimensional array is used as an example of the input data 410 and a 4*4 two-dimensional array is used as an example of the classification information 420. However, the present invention is not limited thereto. In some embodiments, the input data 410 and the classification information 420 may be data of other sizes or other dimensions, for example. In addition, as long as each data unit in the input data 410 can be classified into the first type of data or the second type of data according to the classification information 420, and the classification information 420 may have different sizes and dimensions from the input data 410. In other words, a plurality of bits of the classification information 420 may be in one-to-one correspondence with a plurality of data units in the input data 410, or may be in one-to-many correspondence with a plurality of data units in the input data 410.

Referring back to FIG. 3, the plurality of first operation units 110 are configured to be instantiated according to the classification information 420, and the plurality of instantiated first operation units 110 are configured to densify a plurality of sub data included in the input data 410 into a plurality of sub densified data. Particularly, through a densification operation of the first operation units 110, the sub data are filtered according to the classification information 420, such that the sub densified data do not include the second type of data.

In this embodiment, the first operation unit 110 corresponding to the first sub data (for example, [p₀, p₁, p₂, p₃]) is instantiated according to the first row of sub information (for example, [1, 0, 1, 1]) of the classification information 420. When the instantiated first operation unit 110 acts on the first sub data, the first sub data may be densified into first sub densified data (for example, [p₀, p₂, p₃, 0]). The first sub densified data includes the first type of data and dummy data (such as, but not limited to, 0), but does not include the second type of data. From another perspective, the first type of data of the first sub densified data is valid data (for example, including data units p₀, p₂, and p₃). In some embodiments, the first operation unit 110 corresponding to the first sub data may transmit validity information of the first sub densified data generated by the first operation unit 110 to the second operation unit 120, where the validity information indicates, for example, the number of data units belonging to valid data (for example, 3) or the number of data units not belonging to valid data (for example, 1). The present invention is not limited thereto.

Similarly, the first operation unit 110 corresponding to the second sub data (for example, [p₄, p₅, p₆, p₇]) is instantiated according to the second row of sub information (for example, [0, 0, 1, 1]) of the classification information 420. When the instantiated first operation unit 110 acts on the second sub data, the second sub data may be densified into second sub densified data (for example, [p₆, p₇, 0, 0]). The second sub densified data includes the first type of data and dummy data (such as, but not limited to, 0), but does not include the second type of data. From another perspective, the first type of data of the second sub densified data is valid data (for example, including data units p₆, p₇). In some embodiments, the first operation unit 110 corresponding to the second sub data may transmit validity information of the second sub densified data generated by the first operation unit 110 to the second operation unit 120, where the validity information indicates, for example, the number of data units belonging to valid data (for example, 2) or the number of data units not belonging to valid data (for example, 2). The present invention is not limited thereto.

The first operation unit 110 corresponding to the third sub data (for example, [p₈, p₉, p₁₀, p₁₁]) is instantiated according to the third row of sub information (for example, [0, 1, 1, 1]) of the classification information 420. When the instantiated first operation unit 110 acts on the third sub data, the third sub data may be densified into third sub densified data (for example, [p₉, p₁₀, p₁₁, 0]). The third sub densified data includes the first type of data and dummy data (such as, but not limited to, 0), but does not include the second type of data. From another perspective, the first type of data of the third sub densified data is valid data (for example, including data units p₉, p₁₀, and p₁₁). In some embodiments, the first operation unit 110 corresponding to the third sub data may transmit validity information of the third sub densified data generated by the first operation unit 110 to the second operation unit 120, where the validity information indicates, for example, the number of data units belonging to valid data (for example, 3) or the number of data units not belonging to valid data (for example, 1). The present invention is not limited thereto.

The first operation unit 110 corresponding to the fourth sub data (for example, [p₁₂, p₁₃, p₁₄, p₁₅]) is instantiated according to the fourth row of sub information (for example, [0, 0, 0, 0]) of the classification information 420. When the instantiated first operation unit 110 acts on the fourth sub data, the fourth sub data may be densified into fourth sub densified data (for example, [0, 0, 0, 0]). The sub densified data includes dummy data (such as, but not limited to, 0), but does not include the second type of data. From another perspective, there is no first type of data in the fourth sub densified data, that is, the fourth sub densified data does not include valid data. In some embodiments, the first operation unit 110 corresponding to the fourth sub data may transmit validity information of the fourth sub densified data generated by the first operation unit 110 to the second operation unit 120, where the validity information indicates, for example, the number of data units belonging to valid data (for example, 0) or the number of data units not belonging to valid data (for example, 4). The present invention is not limited thereto.

It is worth mentioning that the valid data as mentioned herein is equivalent to the first type of data obtained according to the classification information 420 in the embodiment of the present invention, but those skilled in the art should understand that the dummy data is not the second type of data obtained according to the classification information 420. More specifically, the dummy data is data used to fill the bit space, and does not include useful information.

Referring to FIGS. 3 and 4, the second operation unit 120 is configured to be instantiated according to the classification information 420, and the instantiated second operation unit 120 is configured to merge a plurality of sub densified data from the plurality of first operation units 110 into densified data 430. Particularly, through the merging operation of the second operation unit 120, the plurality of sub densified data from the plurality of first operation units 110 are translated to overwrite at least part of the dummy data of the plurality of sub densified data and retain the first type of data. Since the second type of data is not included in the plurality of sub densified data from the first operation units 110, the second type of data is not included in the densified data generated by means of the second operation unit 120.

In this embodiment, the second operation unit 120 may, for example, sum up the number of data units belonging to the second type of data corresponding to all the preceding sub data according to the classification information 420, so as to determine the distance of forward translating the corresponding sub densified data when concatenating all the sub densified data. Specifically, in the case of no translation, the plurality of sub densified data of the first operation units 110 are, for example, untranslated data [p₀, p₂, p₃, 0, p₆, p₇, 0, p₉, p₁₀, p₁₁, 0, 0, 0, 0, 0, 0] after being concatenated. In this embodiment, the second operation unit 120 may, for example, translate the plurality of sub densified data from the first operation units 110 according to the classification information 420, such that each sub densified data may be translated forward in order to overwrite the preceding dummy data, thereby obtaining densified data [p₀, p₂, p₃, p₆, p₇, p₉, p₁₀, p₁₁, 0, 0, 0, 0, 0, 0, 0, 0].

It is worth noting that the valid data of the densified data is concentrated at the data front end. Therefore, in some embodiments, the second operation unit 120 may, for example, determine the distance of forward translating corresponding sub densified data when concatenating all the sub densified data according to the validity information from the first operation units 110, so as to concentrate the valid data of all the sub densified data at the data front end of the densified data.

Specifically, in this embodiment, there is no sub data corresponding to other rows before the first sub data, so the forward translation distance of the first sub data is 0; the first sub data before the second sub data includes a data unit p₁ belonging to the second type of data, so the forward translation distance of the second sub data is 1; the first sub data and the second sub data before the third sub data include three data units p₁, p₄ and p₅ belonging to the second type of data, so the forward translation distance of the second sub densified data is 3; and the first sub data, the second sub data and the third sub data before the fourth sub data include four data units p₁, p₄, p₅ and p₈ belonging to the second type of data, so the forward translation distance of the fourth sub densified data is 4. In other embodiments, the data densifier 100 may comprise, for example, more first operation units 110, and the operation mode of the second operation unit 120 may be analogized accordingly, which will not be repeated here.

In some embodiments, the second operation unit 120 may, for example, further filter the valid data (for example, [p₀, p₂, p₃, p₆, p₇, p₉, p₁₀, p₁₁]) of the densified data, and only send the valid data to the transmission element 300 for output.

In some embodiments, the second operation unit 120 may calculate the total number of data units of the valid data of the densified data according to the validity information from the first operation units 110, for example. Accordingly, in addition to sending the densified data to the transmission element 300, the second operation unit 120 also sends the total number of data units of the valid data of the densified data to the transmission element 300 to enable the transmission element 300 to output the valid data of the densified data according to the received total number of data units.

Advantageously, in this embodiment, compared with outputting all the input data 410 of 16 data units, the sense chip 10 outputs, for example, only 8 valid data units without outputting invalid data (for example, dummy data) of the densified data, thus reducing the power consumption during transmission.

Advantageously, in this embodiment, the plurality of first operation units 110 are, for example, configured to operate in parallel to densify a plurality of sub data into a plurality of sub densified data in parallel, such that the latency during data transmission may be reduced.

In some embodiments, such a design can realize a pipeline process to further accelerate data transmission. Taking the sense chip 10 in FIG. 2 as an example, the light sensing element 200 may obtain, for example, image data of 8*4 pixels. First, the plurality of first operation units 110 read out the image data of the first four rows from the light sensing element 200 in, for example, x time cycles, and generate and output sub densified data corresponding to the image data of the first four rows according to the methods described in the embodiments in FIGS. 3 and 4, and then the second operation unit 120 generates and outputs data (for example, densified data corresponding to the image data of the first four rows) in y time cycles. Accordingly, in the y time cycles in which the second operation unit 120 generates and outputs data, the plurality of first operation units 110 may, for example, read out the image data of the last four rows from the light sensing element 200, and generate and output sub densified data corresponding to the image data of the last four rows according to the methods described in the embodiments in FIGS. 3 and 4. Therefore, as long as x and y are well controlled, the data densifier 100 can realize pipeline process and reduce latency.

The implementation details of the first operation units and the second operation unit of the present invention will be further described with embodiments below.

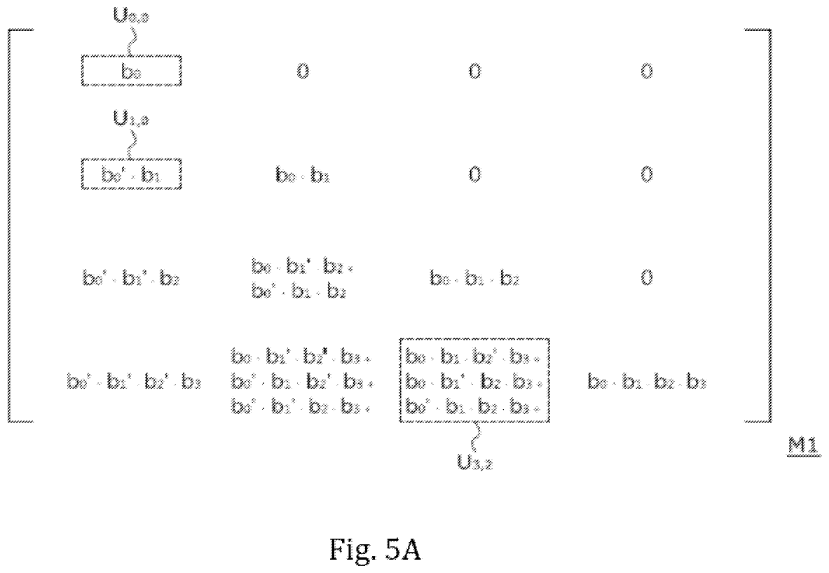

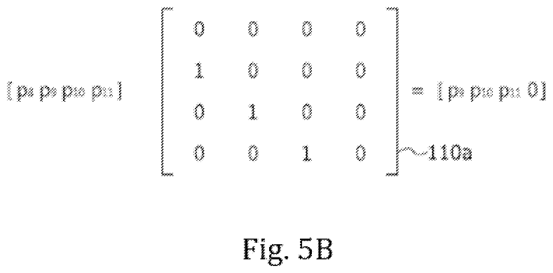

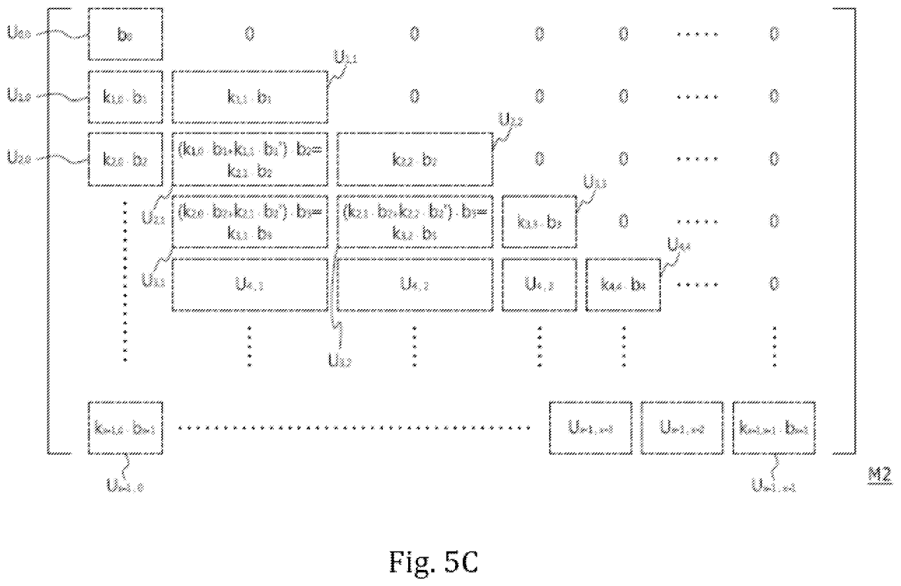

FIG. 5A shows a schematic diagram of a first operation unit in an embodiment of the present invention; and FIG. 5B shows a schematic diagram of an instantiated first operation unit in an embodiment of the present invention.

Referring to FIG. 5A first, the first operation unit 110 may be designed to operate as a lower triangular matrix M1, having a size equal to a corresponding sub data length, for example. It must be noted that the lower triangular matrix M1 in FIG. 5A is an example to illustrate the first operation unit 110 with a corresponding sub data length of 4. However, the present invention is not limited thereto. In other embodiments, when the sub data lengths are different, those skilled in the art can apply the concepts introduced in this embodiment to the first operation units 110 corresponding to other sub data lengths.

Referring to FIG. 5A, in this embodiment, b₀, b₁, b₂ and b₃ are, for example, the classification of each data unit in the sub data corresponding to the first operation unit 110. Therefore, b₀, b₁, b₂ and b₃ are each one of the bits in the corresponding classification information 420. For example, four data units p₀, p₁, p₂, and p₃ corresponding to the first sub data may be divided into a first type of data, a second type of data, a first type of data and a first type of data according to the first row of sub information [1, 0, 1, 1] in the classification information 420, so b₀, b₁, b₂, b₃ are, for example, 1, 0, 1, 1 respectively; four data units p₄, p₅, p₆ and p₇ corresponding to the second sub data may be divided into a second type of data, a second type of data, a first type of data and a first type of data according to the second row of sub information [0, 0, 1, 1] in the classification information 420, so b₀, b₁, b₂ and b₃ are, for example, 0, 0, 1, 1 respectively; and four data units p₈, p₉, p₁₀ and p₁₁ corresponding to the third sub data may be divided into a second type of data, a first type of data, a first type of data and a first type of data according to the third row of sub information [0, 1, 1, 1] in the classification information 420, so b₀, b₁, b₂ and b₃ are, for example, 0, 1, 1, 1 respectively, and so on. As such, the plurality of first operation units 110 may be instantiated according to the classification information 420.

Referring to FIG. 5B, in this embodiment, the first operation unit 110 corresponding to the third sub data [p₈, p₉, p₁₀, p₁₁] may be instantiated as a first operation unit 110a according to the classification information 420. As can be seen from FIG. 5B, when the instantiated first operation unit 110a acts on the third sub data [p₈, p₉, p₁₀, p₁₁], the third sub densified data [p₉, p₁₀, p₁₁, 0] may be obtained. The instantiation of the first operation units 110 corresponding to the first sub data, the second sub data, and the fourth sub data may be analogized, which will not be repeated herein.

It should be understood by those skilled in the art that since the data unit in this embodiment may include one or more bits, the multiplication operation performed on the data unit in this embodiment is to multiply each bit in the data unit separately. For example, p₈·b₀ means that every bit in the data unit p₈ is multiplied by b₀.

In some embodiments, the plurality of first operation units 110 may also be implemented by software. For example, the plurality of first operation units 110 may be implemented as a plurality of functions in the form of a lower triangular matrix M1, with variables b₀, b₁, b₂ and b₃. Therefore, these functions may be instantiated according to the classification information 420.

In some embodiments, the plurality of first operation units 110 may be pre-designed logic circuits, and each logic circuit corresponding to each first operation unit 110 may be designed as a lower triangular matrix M1 to save logic elements above the diagonal. Therefore, these logic circuits may be instantiated according to the classification information 420.

In this embodiment, a sub operation unit U_{0,0} corresponding to row 0 and column 0 of the lower triangular matrix M1 is instantiated according to b₀, for example; a sub operation unit U_{1,0} corresponding to row 1 and column 0 of the lower triangular matrix M1, includes, but is not limited to, for example, an inverting element (for example, an inverter) and a multiplication element (for example, an AND gate), and is instantiated according to b₀ and b₁; a sub operation unit U_{3,2} corresponding to row 3 and column 2 of the lower triangular matrix M1 includes, but is not limited to, for example, a plurality of inverters, a plurality of multiplication elements and a plurality of addition elements (for example, OR gates), and is instantiated according to b₀, b₁, b₂, b₃, and so on.

Based on the lower triangular matrix M1 introduced in the embodiment in FIG. 5A, the plurality of first operation units 110 may be implemented by software or hardware, and these first operation units 110 may be instantiated according to the classification information 420.

However, it must be noted that when the first operation unit 110 is implemented based on the lower triangular matrix M1 introduced in the embodiment in FIG. 5A, the amount of calculations required for instantiation increases nonlinearly with the size of the lower triangular matrix M1 (that is, the sub data length corresponding to the first operation unit 110), so the time required for instantiation increases nonlinearly. Furthermore, when the first operation unit 110 is implemented by hardware based on the lower triangular matrix M1, the number of logic elements used may also increase nonlinearly with the size of the lower triangular matrix M1. In the following, another embodiment of the present invention will be introduced, which can reduce the number of required logic elements in hardware implementation and reduce the required calculation time or save calculation power in software implementation.

FIG. 5C shows a schematic diagram of a first operation unit in an embodiment of the present invention.

Referring to FIG. 5C, the first operation unit 110 may be designed to operate as a lower triangular matrix M2, for example. In this embodiment, the sub data length corresponding to the first operation unit 110 is, for example, x, so the lower triangular matrix M2 is an x*x matrix. In addition, b₀, b₁, . . . , bₓ₋₁ are, for example, the classification of each data unit in the sub data corresponding to the first operation unit 110. Therefore, each of b₀, b₁, . . . , bₓ₋₁ is one bit in the corresponding classification information 420. For example, when x is 4, the first operation unit 110 may be instantiated as a first operation unit 110a in FIG. 5B based on the lower triangular matrix M2 in FIG. 5C according to the classification information 420.

In this embodiment, the sub operation unit U_{0,0} corresponding to row 0 and column 0 is instantiated according to b₀ in the classification information, for example.

In this embodiment, when m≠0 or n≠0, and m>n, the sub operation unit U_{m,n} corresponding to row m and column n of the lower triangular matrix M2 comprises a first operator and a second operator, and an output of the second operator may be used to represent the instantiated sub operation unit U_{m,n}.

In this embodiment, the second operator may be represented as, for example, “_·_”, where “_” is used to represent, for example, input, and “·” is used to represent, for example, a multiplication operator. Specifically, the input of the second operator of the sub operation unit U_{m,n} includes the outputs K_{m,n} and bₘ of the first operator, and the sub operation unit U_{m,n} is instantiated as K_{m,n}·bₘ by the output of the second operator.

In this embodiment, the first operator of the sub operation unit U_{m,0} corresponding to row m and column 0 of the lower triangular matrix M2 may be represented as “_·_”, where “_” is used to represent, for example, input; “·” is used to represent, for example, a multiplication operator; and “′” is used to represent, for example, an inversion operator. Specifically, the input of the first operator of the sub operation unit U_{m,0} includes K_{m-1,0} and bₘ₋₁, and the output is K_{m,0}=K_{m-1,0}−bₘ₋₁′. For example, the inputs of the first operator of the sub operation unit U_{1,0} corresponding to column 0 and row 1 of the lower triangular matrix M2 are K_{0,0} and b₀, where K_{0,0} is 1, so the output of the first operator of the sub operation unit U_{1,0} is, for example, k_{1,0}=b₀′; the inputs of the first operator of the sub operation unit U_{2,0} corresponding to column 0 and row 2 of the lower triangular matrix M2 are K_{1,0} and b₁, where K_{1,0} is b₀, so the output of the first operator of the sub operation unit U_{2,0} is, for example, K_{2,0}=b₀′·b₁′, and so on. Accordingly, all the sub-operational units U_{1,0}, U_{2,0}, . . . , U_{x-1,0} corresponding to column 0 of the lower triangular matrix M2 may be instantiated recursively.

In this embodiment, the first operator of the sub operation unit U_{m,m} corresponding to row m and column m of the lower triangular matrix M2 may be represented as “_·_”, where “_” is used to represent, for example, input, and “·” is used to represent, for example, a multiplication operator. Specifically, the inputs of the first operator of the sub operation unit U_{m,m} include K_{m-1,m-1} and bₘ₋₁, and the output is k_{m,m}=k_{m-1,m-1}·bₘ₋₁. For example, the inputs of the first operator of the sub operation unit U_{1,1} corresponding to column 1 and row 1 of the lower triangular matrix M2 are K_{0,0} and b₀, where K_{0,0} is 1, so the output of the first operator of the sub operation unit U_{1,1} is, for example, K_{1,1}=b₀; the inputs of the first operator of the sub operation unit U_{2,2} corresponding to column 2 and row 2 of the lower triangular matrix M2 are K_{1,1} and b₁, where K_{1,1} is b₀, so the output of the first operator of the sub operation unit U_{2,2} is, for example, K_{2,2}=b₀·b₁, and so on. Accordingly, all the sub operation units U_{1,1}, U_{2,2}, . . . , U_{x-1,x-1} on the diagonal of the lower triangular matrix M2 may be instantiated recursively.

In this embodiment, when n≠0 and m·n, the first operator of the sub operation unit U_{m,n} corresponding to row m and column n of the lower triangular matrix M2 may be represented as “_·_+_·_′”, where “_” is used to represent, for example, input, “·” is used to represent, for example, a multiplication operator, and “′” is used to represent, for example, an inversion operator. Specifically, the inputs of the first operator of the sub operation unit U_{m,n} include K_{m-1,n-1}, K_{m-1,n} and bₘ₋₁, and the output is k_{m,n}=K_{m-1,n-1}·bₘ₋₁+K_{m-1,n}·bₘ₋₁′. For example, the inputs of the first operator of the sub operation unit U_{2,1} corresponding to column 2 and row 1 of the lower triangular matrix M2 are K_{1,0}, K_{1,1} and b₁, where the values of K_{1,0}, and K_{1,1} have been calculated by the above-mentioned way, so the output K_{2,1} of the first operator of the sub operation unit U_{2,1} may be obtained based on the values of K_{1,0} and K_{1,1}, and b₁ in the classification information 420; the inputs of the first operator of the sub operation unit U_{3,1} corresponding to column 3 and row 1 of the lower triangular matrix M2 are K_{2,0}, K_{2,1} and b₂, where the values of K_{2,0}, and K_{2,1} have been calculated by the above-mentioned way, for example, so the output K_{3,1} of the first operator of the sub operation unit U_{3,1} may be obtained according to the values of K_{2,0} and K_{2,1}, and b₂ in the classification information 420; the inputs of the first operator of the sub operation unit U_{3,2} corresponding to column 3 and row 2 of the lower triangular matrix M2 are K_{2,1}, K_{2,2} and b₂, where the values of K_{2,1},and K_{2,2} have been calculated by the above-mentioned way, for example, so the output K_{3,2} of the first operator of the sub operation unit U_{3,2} may be obtained according to the values of K_{2,1} and K_{2,2}, and b₂ in the classification information 420, and so on. Accordingly, all the other sub operation units U_{2,1}, U_{3,1}, U_{3,2}, U_{4,1}, U_{4,2}, U_{4,3}, . . . , U_{x-1,x-3}, U_{x-1,x-2} corresponding to the lower triangular matrix M2 may be instantiated recursively.

It can be seen from the above description that when the first operation unit 110 is implemented based on the lower triangular matrix M2 introduced in the embodiment in FIG. 5C, the amount of calculations required for instantiating its sub operation units may not increase exponentially with the size of the lower triangular matrix M2 (that is, the sub data length corresponding to the first operation unit 110), so the time required for instantiation may not increase exponentially with the size of the lower triangular matrix M2. For example, the amount of calculations required by the sub operation unit U_{m,n} of the first operation unit 110 is at most three multiplication operations, one addition operation and one inversion operation. In other words, when implementing the first operation unit 110 by hardware based on the lower triangular matrix M2 described in the embodiment in FIG. 5C, the number of logic elements used may not exponentially increase either with the size of the lower triangular matrix M2.

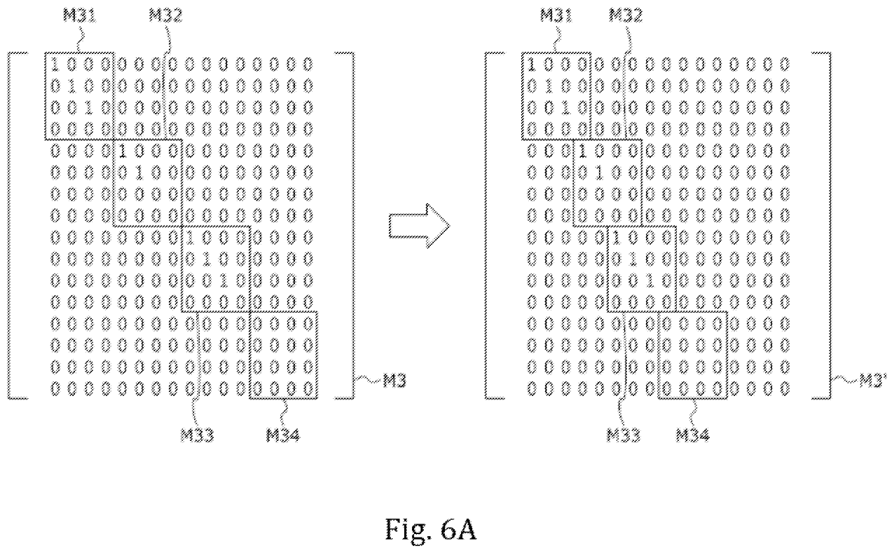

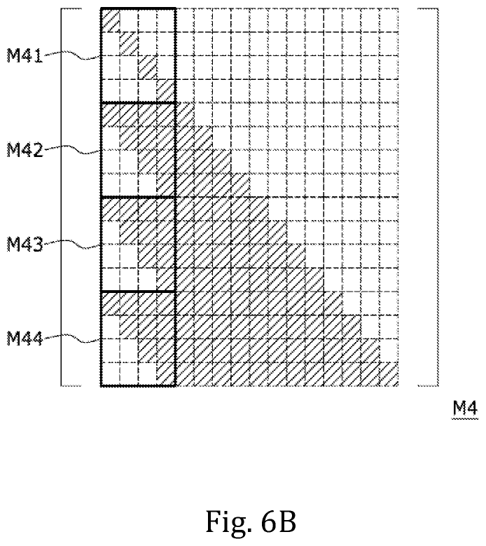

FIG. 6A shows a schematic diagram of a second operation unit in an embodiment of the present invention.

Referring to FIG. 6A, in this embodiment, the second operation unit 120 is illustrated by a diagonal matrix M3 and a lower triangular matrix M3, where the second operation unit 120 may be designed to operate as the lower triangular matrix M3, for example, to translate a plurality of sub densified data from the plurality of first operation units 110, so as to overwrite part of dummy data of the plurality of sub densified data and retain the first type of data.

Specifically, the diagonal matrix M3 diagonally includes a plurality of sub-diagonal matrices M31, M32, M33, M34 respectively corresponding to the plurality of first operation units 110, and the size of each of the sub-diagonal matrices M31, M32, M33 and M34 is equal to a corresponding sub data length, for example. Therefore, the number of the sub-diagonal matrices M31, M32, M33 and M34 is equal to the number of the first operation units 110. It must be noted that the lower triangular matrix M3 in FIG. 6A is an example to illustrate 4 first operation units 110 each with a corresponding sub data length of 4. However, the present invention is not limited thereto. Those skilled in the art can apply the concepts introduced in this embodiment to other numbers of first operation units 110, and the corresponding sub data length of each first operation unit 110 may not be 4.

In this embodiment, each of the sub-diagonal matrices M31, M32, M33 and M34 of the diagonal matrix M3 is associated with the classification information 420 or is associated with the validity information from the first operation unit 110, for example.

Specifically, the first n elements on the diagonal of each of the sub-diagonal matrices M31, M32, M33 and M34 are 1, others are 0, and n is equal to the number of data units of the first type of data (i.e., valid data) of the sub densified data corresponding to each of the sub-diagonal matrices M31, M32, M33 and M34. For example, the first sub densified data [p₀, p₂, p₃, 0] corresponding to the sub-diagonal matrix M31 includes 3 data units p₀, p₂, p₃ belonging to the first type of data (that is, valid data), so the sub-diagonal matrix M31 includes three 1 followed by one 0 on the diagonal; the second sub densified data [p₆, p₇, 0, 0] corresponding to the sub-diagonal matrix M32 includes 2 data units p₆ and p₇ belonging to the first type of data (that is, valid data), so the sub-diagonal matrix M32 includes two 1 followed by two 0 on the diagonal; the third sub densified data [p₉, p₁₀, p₁₁, 0] corresponding to the sub-diagonal matrix M33 includes 3 data units p₉, p₁₀ and p₁₁ belonging to the first type of data (that is, valid data), so the sub-diagonal matrix M33 includes three 1 followed by one 0 on the diagonal; the fourth sub densified data [0, 0, 0, 0] corresponding to the sub-diagonal matrix M34 does not include data units belonging to the first type of data (that is, valid data), so the sub-diagonal matrix M34 includes four 0 but does not include 1 on the diagonal.

In this embodiment, the lower triangular matrix M3′ is, for example, a result of forward translating the plurality of sub-diagonal matrices M31, M32, M33 and M34 in the diagonal matrix M3, and the forward translation distance of each of the sub-diagonal matrices M31, M32, M33 and M34 is equal to the sum of the number of data units belonging to the second type of data or invalid data in all the corresponding preceding sub data. In some embodiments, the sum of the number of data units belonging to the second type of data or invalid data in all the preceding sub data can also be obtained by summing up the number of dummy data units of all the preceding sub densified data, or summing up the number of 0 on the diagonal of the preceding sub-diagonal matrix in the sub-diagonal matrix M3. In some embodiments, the distance of forward translation is calculated according to the validity information from the first operation unit 110. In other words, those skilled in the art can implement the above sum based on the concepts introduced above, but the specific implementation is not limited thereto.

For example, the sub-diagonal matrix M31 in the diagonal matrix M3 is a first sub-diagonal matrix, so the sub-diagonal matrix M31 is not translated; the sub-diagonal matrix M32 in the diagonal matrix M3 is a second sub-diagonal matrix, and the sub-diagonal matrix M31 before the sub-diagonal matrix M32 includes one 0, so the sub-diagonal matrix M32 is translated forward by 1 column; the sub-diagonal matrix M33 in the diagonal matrix M3 is a third sub-diagonal matrix, and the sub-diagonal matrices M31 and M32 before the sub-diagonal matrix M33 include three 0 in total, so the sub-diagonal matrix M33 is translated forward by 3 columns; the sub-diagonal matrix M34 in the diagonal matrix M3 is a fourth sub-diagonal matrix, and the sub-diagonal matrices M31, M32 and M33 before the sub-diagonal matrix M34 include four 0, so the sub-diagonal matrix M34 is translated forward by 4 columns. After all the sub-diagonal matrices M31, M32, M33 and M34 are translated, the lower triangular matrix M3′ may be obtained.

In this embodiment, the plurality of sub densified data of the first operation units 110 are, for example, untranslated data [p₀, p₂, p₃, 0, p₆, p₇, 0, 0, p₉, p₁₀, p₁₁, 0, 0, 0, 0, 0] after being concatenated. After the second operation unit 120 operating as the lower triangular matrix M3′ acts on the untranslated data, each sub densified data may be translated forward in order to overwrite the preceding dummy data, and then densified data [p₀, p₂, p₃, p₆, p₇, p₉, p₁₀, p₁₁, 0, 0, 0, 0, 0, 0, 0, 0] may be obtained. It is worth noting that the valid data of the densified data is concentrated at the data front end. In this embodiment, in addition to the valid data, the densified data also includes dummy data, the valid data in the dummy data is concentrated at the data front end, and the dummy data in the densified data is concentrated at the data back end.

It is worth mentioning that since the size of each first operation unit 110 may be preset, after the classification information 420 is obtained, the second operation unit 120 operating as a lower triangular matrix may be instantiated according to the classification information 420 to operate as the lower triangular matrix M3, and then act on the plurality of above-mentioned sub densified data or untranslated data.

In some embodiments, the second operation unit 120 may be implemented by software. For example, the second operation unit 120 may be implemented as a function in the form of a lower triangular matrix, with the variable being the classification information 420. This function may be instantiated as the lower triangular matrix M3′ according to the classification information 420.

In some embodiments, the second operation unit 120 may be a pre-designed logic circuit, which may be designed, for example, as a lower triangular matrix, to save logic elements above the diagonal. This logic circuit may be instantiated as the lower triangular matrix M3′ according to the classification information 420, for example.

FIG. 6B shows a schematic diagram of a second operation unit in an embodiment of the present invention.

When the second operation unit 120 is designed as a logic circuit in the form of a lower triangular matrix, more logic elements may be further saved in addition to the logic elements above the diagonal.

Referring to FIG. 6A first, the forward translation distance of each of the sub-diagonal matrices M31, M32, M33 and M34 does not exceed the total number of columns of the preceding sub-diagonal matrix. Therefore, the first n columns of the lower triangular matrix M3′ may include a diagonal matrix and a plurality of upper triangular matrices, where n is the maximum width in the sub-diagonal matrices M31, M32, M33 and M34.

Referring to FIG. 6B, in this embodiment, because the maximum width in the sub-diagonal matrices M31, M32, M33 and M34 is 4, when the second operation unit 120 is implemented as a lower triangular matrix M4 by a logic circuit, the first four columns include a diagonal matrix M41, an upper triangular matrix M42, an upper triangular matrix M43 and an upper triangular matrix M44 respectively from the top down. In other words, in addition to saving logic elements above the diagonal of diagonal matrix M4, logic elements below the diagonals of the upper triangular matrix M42, the upper triangular matrix M43 and the upper triangular matrix M44 may be further saved. Taking FIG. 6B as an example, in the lower triangular matrix M4, only the elements marked with diagonal lines need to be implemented by means of logic elements.

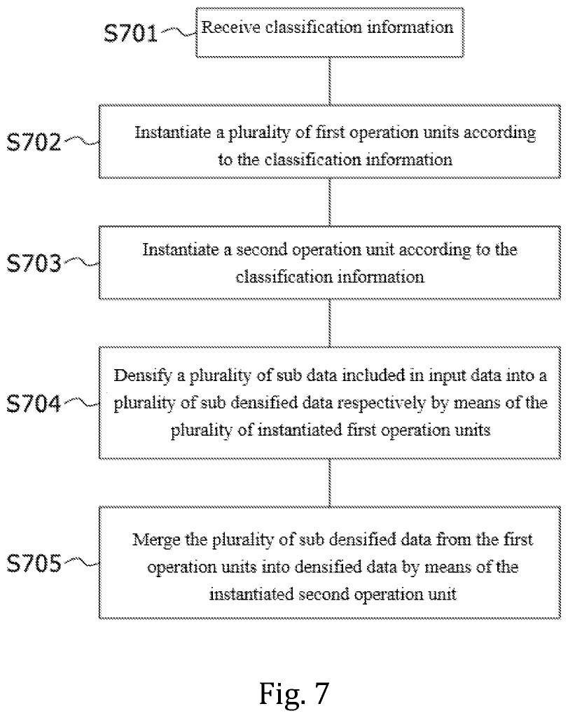

FIG. 7 shows a flowchart of a data densification method in an embodiment of the present invention.

The data densification method introduced in the embodiment in FIG. 7 is applicable to the data densifier 100 in the foregoing embodiment, so the details introduced in the foregoing embodiment are not repeated here. It must be noted that steps S701 to S705 shown in the flowchart of FIG. 7 are used to explain the necessary steps in the flow, and there is no restriction on the execution order. For example, step S702 and step S703 may be executed sequentially or simultaneously. For another example, step S703 may be executed after step S704 instead of before step S704. In other words, those skilled in the art can adjust the sequential order of the steps in the flowchart of FIG. 7 according to their needs.

Referring to FIG. 7, the data densifier 100 may receive classification information in step S701. In step S702, a plurality of first operation units 110 in the data densifier 100 may be instantiated according to the classification information. In step S703, a second operation unit 120 in the data densifier 100 may be instantiated according to the classification information. In step S704, the plurality of instantiated first operation units 110 may respectively densify a plurality of sub data included in input data into a plurality of sub densified data. In step S705, the instantiated second operation unit 120 may merge the plurality of sub densified data from the first operation units 110 into densified data.

To sum up, according to the data densification method, the data densifier using the data densification method, and the sense chip proposed in the embodiments of the present invention, a plurality of sub data included in input data are densified into a plurality of sub densified data in parallel first, and then the plurality of sub densified data are merged into densified data. The sense chip in the embodiment of the present invention may output valid data of the densified data rather than all the input data. Accordingly, low latency may be achieved while reducing output power consumption.

The embodiments as shown and set forth above are only exemplary embodiments. Many other details can usually be found in the art. Therefore, many details are not shown or set forth. Even though many features and advantages of the present invention have been illustrated in the foregoing paragraphs with the functions and structures of the present invention, this specification is only an example, and it is possible to modify details, such as shapes, sizes and configurations of components, on the premise of conforming to the principles of the present invention and fully considering the broadest interpretation scope of the terms. It should be understood by those skilled in the art that the technical solutions of the present invention can be modified or replaced by equivalents without departing from the spirit and essence of the technical solutions of the present invention.

What is claimed is:

1. A data densifier, comprising:
a plurality of first operation units, the plurality of first operation unit being respectively configured to be instantiated according to classification information, and the plurality of instantiated first operation units being configured to densify a plurality of sub data included in input data into a plurality of sub densified data; and
a second operation unit, the second operation unit being configured to be instantiated according to the classification information, and the instantiated second operation unit being configured to merge the plurality of sub densified data into densified data.

2. The data densifier of claim 1, wherein the input data is divided into a first type of data and a second type of data according to the classification information, and the plurality of sub densified data and the densified data do not include the second type of data.

3. The data densifier of claim 2, wherein the plurality of sub densified data comprise the first type of data and dummy data, and the second operation unit is configured to translate the plurality of sub densified data to overwrite the dummy data and retain the first type of data.

4. The data densifier of claim 2, wherein each of the plurality of first operation units is configured to operate as a lower triangular matrix.

5. The data densifier of claim 4, wherein when m≠0 or n≠0, a sub operation unit corresponding to a row m and a column n of the lower triangular matrix comprises a first operator and a second operator, and an input of the second operator comprises an output of the first operator and one bit in the classification information.

6. The data densifier of claim 5, wherein when n=0 and m≠0, or m=n≠0, the input of the first operator of the sub operation unit corresponding to the row m and the column n of the lower triangular matrix is associated with at least one bit in the classification information.

7. The data densifier of claim 5, wherein when m≠0 and n≠0, the input of the first operator of the sub operation unit corresponding to the row m and the column n of the lower triangular matrix comprises:
an output of a first operator of a sub operation unit corresponding to a row m−1 and a column n−1 of the lower triangular matrix;
an output of a first operator of a sub operation unit corresponding to a row m−1 and a column n of the lower triangular matrix; and
one bit in the classification information.

8. The data densifier of claim 1, wherein the second operation unit is configured to operate as a lower triangular matrix.

9. The data densifier of claim 8, wherein the first plurality of columns of the lower triangular matrix comprise one diagonal matrix and a plurality of upper triangular matrices.

10. A sense chip, comprising:
the data densifier of claim 1;
a light sensing element coupled to the data densifier, and configured to generate the input data; and
a transmission element coupled to the data densifier, and configured to be coupled to an external element to output valid data of the densified data to the external element.

11. A data densification method, comprising:
receiving classification information;
instantiating a plurality of first operation units according to the classification information;
instantiating a second operation unit according to the classification information;
densifying a plurality of sub data included in input data into a plurality of sub densified data respectively by means of the plurality of instantiated first operation units; and
merging the plurality of sub densified data into densified data by means of the instantiated second operation unit.

12. The data densification method of claim 11, wherein the input data is divided into a first type of data and a second type of data according to the classification information, and the plurality of sub densified data and the densified data do not include the second type of data.

13. The data densification method of claim 12, wherein the plurality of sub densified data comprise the first type of data and dummy data, and the merging the plurality of sub densified data into the densified data by means of the instantiated second operation unit comprises:
translating the plurality of sub densified data by means of the instantiated second operation unit to overwrite the dummy data and retain the first type of data.

14. The data densification method of claim 12, wherein each of the plurality of first operation units operates as a lower triangular matrix.

15. The data densification method of claim 14, wherein when m≠0 or n≠0, a sub operation unit corresponding to a row m and a column n of the lower triangular matrix comprises a first operator and a second operator, and instantiating the plurality of first operation units according to the classification information comprises:
instantiating the second operator according to an output of the first operator and one bit in the classification information.

16. The data densification method of claim 15, wherein the instantiating the plurality of first operation units according to the classification information further comprises:
when n=0 and m≠0, or m=n≠0, instantiating the first operator of the sub operation unit corresponding to the row m and the column n of the lower triangular matrix according to at least one bit in the classification information.

17. The data densification method of claim 15, wherein instantiating the plurality of first operation units according to the classification information further comprises:
when n≠0 and m≠n, according to
an output of a first operator of a sub operation unit corresponding to a row m−1 and a column n−1 of the lower triangular matrix,
an output of a first operator of a sub operation unit corresponding to a row m−1 and a column n of the lower triangular matrix, and
one bit in the classification information,
instantiating the first operator of the sub operation unit corresponding to the row m and the column n of the lower triangular matrix.

18. The data densification method of claim 11, wherein the second operation unit operates as a lower triangular matrix.

19. The data densification method of claim 18, wherein the first plurality of columns of the lower triangular matrix comprise one diagonal matrix and a plurality of upper triangular matrices.
